(19) United States
(12) Patent Application Publication
(10) Pub. No.: US 2011/0153885 A1
(43) Pub. Date: Jun. 23, 2011

(54) Plug-in Peripheral Device for Enabling Smart Portable Device to be Universal Remote Control

(76) Inventors: Tony K. Mak, San Francisco, CA (US); Hei Tao Fung, Newark, CA (US)

(21) Appl. No.: 12/642,814

(22) Filed: Dec. 20, 2009

(51) Int. Cl. G06F 13/42

(52) U.S. Cl. 710/106

(57) ABSTRACT

The smart portable device such as a smart phone is equipped with powerful CPU, touch screen, USB socket, etc. The software application running on the smart portable device can convert the user commands received on the graphical user interface (GUI) into remote control codes and communicate the remote control codes as data packets through peripheral bus interface, such as USB, to a plug-in peripheral device. The plug-in peripheral device receives the data packets and drives the IR transmitter using information in the data packets received. The remote control codes in the form of modulated IR signals arrive at the electronic appliances such as TV, VCR, Hi-Fi systems, robots, etc. that can decode remote control codes.

### FIELD OF THE INVENTION

The present invention relates to a universal remote control device. More specifically the present invention relates to enabling a smart mobile device to be a universal remote control device.

### BACKGROUND

Nowadays many consumer electronic appliances come with their own distinct and proprietary remote controls. Those remote controls have been using infrared (IR) signals to convey remote control codes corresponding to user commands to the electronic appliances, which have IR remote control decoder embedded. An average household may have a number of remote controls for television, DVD player, hi-fi system, set-top box, etc. In order to alleviate the confusion and hassle of handling multiple remote controls, technologies have been developed to integrate the functionality of all remote controls into one universal remote control. Nowadays, the advanced universal remote controls may have touch screen and user-friendly interface.

Meanwhile, the portable computing device technologies have made a leap. There are advanced mobile phones, PDA, etc., collectively referred to as smart portable devices herein, that possess powerful CPU, touch screen, peripheral bus interface such as USB socket, networking interface, etc. Those smart portable devices are capable of running software applications that can control various device resources. The current invention discloses an apparatus and methods that allow the smart portable devices to convey remote control codes to the electronic appliances.

### SUMMARY OF THE INVENTION

A plug-in peripheral device such as a USB plug-in and methods for enabling smart portable devices to be universal remote controls is disclosed. The smart portable device such as a smart phone is equipped with powerful CPU, touch screen, peripheral bus interface, such as USB socket, etc. The software application running on the smart portable device can convert the user commands received on the graphical user interface (GUI) into remote control codes and communicate the remote control codes in data packets through the peripheral bus interface such as USB socket to the plug-in peripheral device. The plug-in peripheral device receives the data packets and drives the IR signal transmitter using information in the data packets received. The remote control codes in the form of modulated IR signals arrive at the electronic appliances such as TV, VCR, Hi-Fi systems, robots, etc. that can decode remote control codes

### BRIEF DESCRIPTION OF THE DRAWINGS/FIGURES

The present invention will be understood more fully from the detailed description that follows and from the accompanying drawings, which however, should not be taken to limit the disclosed subject matter to the specific embodiments shown, but are for explanation and understanding only.

FIG. 1 illustrates how an embodiment of the invention disclosed is deployed.

FIG. 2 illustrates the PDU format used to convey a remote control code in our preferred embodiment.

FIG. 3 illustrates how a remote control code is encoded in the PDU.

FIG. 4 illustrates how a PDU is carried inside a USB data packet.

FIG. 5 shows an embodiment of the plug-in peripheral device disclosed.

### DETAILED DESCRIPTION OF THE INVENTION

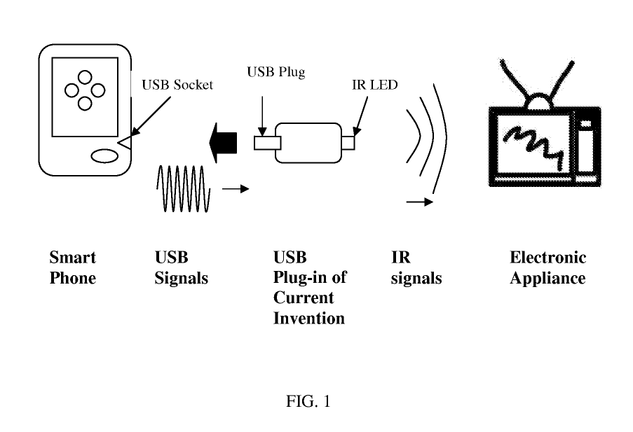

A plug-in peripheral device and methods for enabling smart portable devices to be universal remote controls is disclosed. FIG. 1 shows a deployment example of an embodiment of the invention disclosed. The smart portable device such as a smart phone is equipped with powerful CPU, touch screen, peripheral bus interface, networking interface, etc. Among the peripheral bus interfaces, Universal Serial Bus (USB) is the most common. In our preferred embodiment of the current invention, the smart portable device has a USB socket, and the plug-in peripheral device is a USB plug-in. The smart portable device also acts as the USB host. The software application running on the smart portable device can convert the user commands received on the graphical user interface (GUI) into remote control codes specific to the electronic appliance to be controlled. The remote control codes are transmitted as USB data packets to the USB plug-in through the USB socket. The USB plug-in acts as the USB device in the current invention. In our preferred embodiment, the USB plug-in receives power from the smart mobile device through the USB power pins. It receives and decodes the USB data packets and uses the retrieved remote control codes from USB data packets to control the on/off switch of an IR signal transmitter. The electronic appliances receive and demodulate the IR signals to recover the remote control codes.

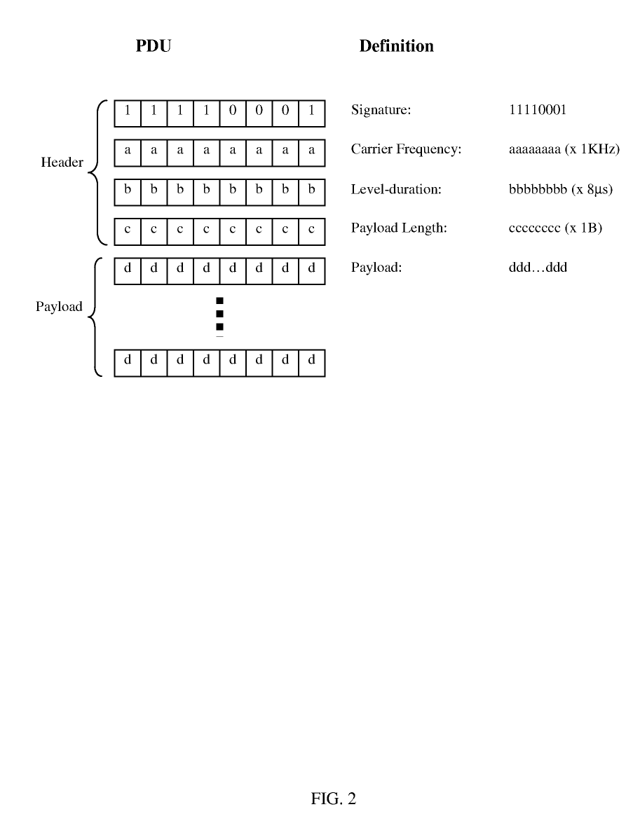

FIG. 2 shows the format of the protocol data unit (PDU) used to convey a remote control code. Each PDU comprises a header of four bytes, followed by a variable length of data bytes representing the logic levels of a remote control code. The PDU header comprises a one-byte signature field, a one-byte carrier frequency field, a one-byte level-duration field, and a one-byte length field. The signature field has value ‘11110001.’ The carrier frequency field represents the infrared (IR) carrier frequency in units of KHz. The level-duration field represents the duration of each logic level in the remote control code in units of eight microseconds. The length field represents the number of bytes of the payload to follow. The payload carries the sequence of logic levels of a remote control code.

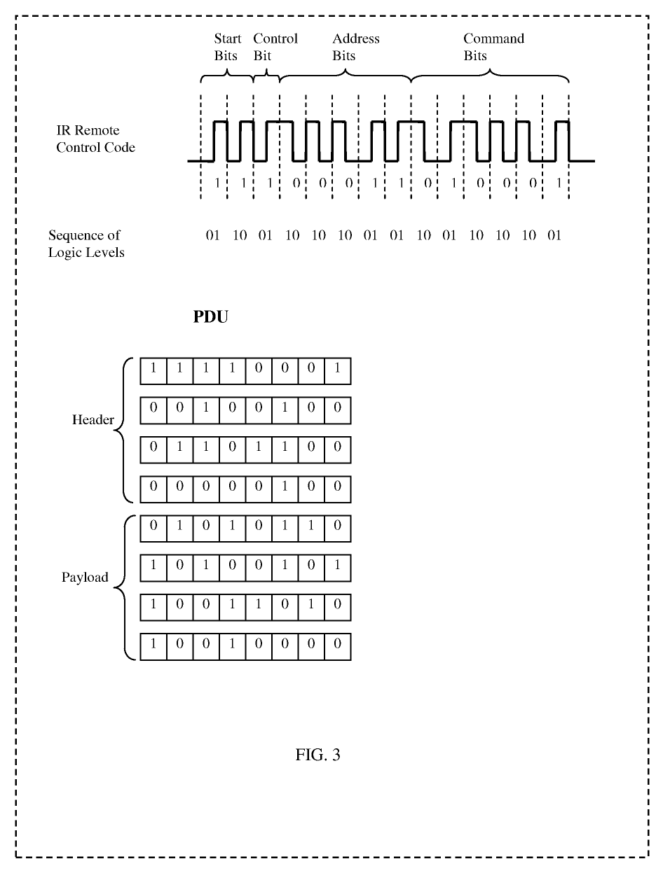

FIG. 3 illustrates how a remote control code is encoded in the PDU. FIG. 3 shows a Philips RC5 IR remote control code, which comprises two starting bits, one toggle bit, five address bits, and six commands bits. In RC5, each bit is represented by a logic level transition. Bit value 1 is represented by transition from level low to level high. Bit value 0 is represented by transition from level high to level low. Therefore, a RC5 IR remote control code can be represented by a sequence of logic levels. The duration of a logic level is electronic appliance specific, and in this example, it is 864 microsecond, and the carrier frequency is 36 KHz. The sequence of logic levels representing the remote control code has 28 units. It is padded with 4 more units of logic level 0 to make up a four-byte payload.

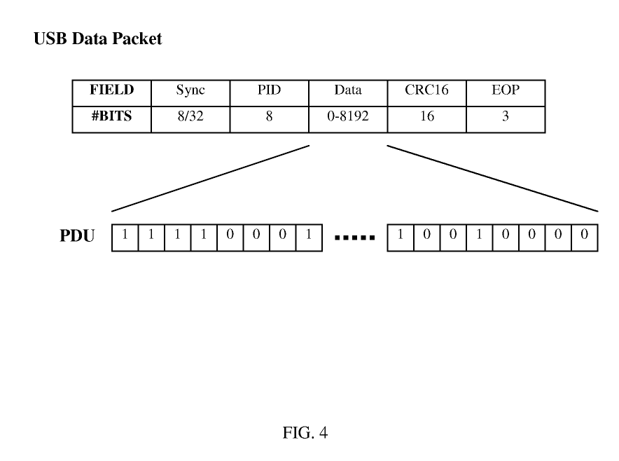

A PDU is converted into USB data packet for communicating over USB to the USB plug-in. Refer to FIG. 4. In our preferred embodiment, the USB plug-in operates in low speed mode so that the implementation complexities of the USB protocol handling can be minimized. A USB data packet shall consist of at most eight bytes of data in low speed mode. Therefore, the PDU may be transmitted in one or more USB data packets.

The USB plug-in receives the USB data packets and reconstructs the PDU. The USB plug-in uses the level-duration field value and the carrier frequency field value in the PDU header and the sequence of logic levels of the remote control code in the PDU payload to control the emission of IR signals. Consequently, the remote control code is transmitted as modulated IR signals.

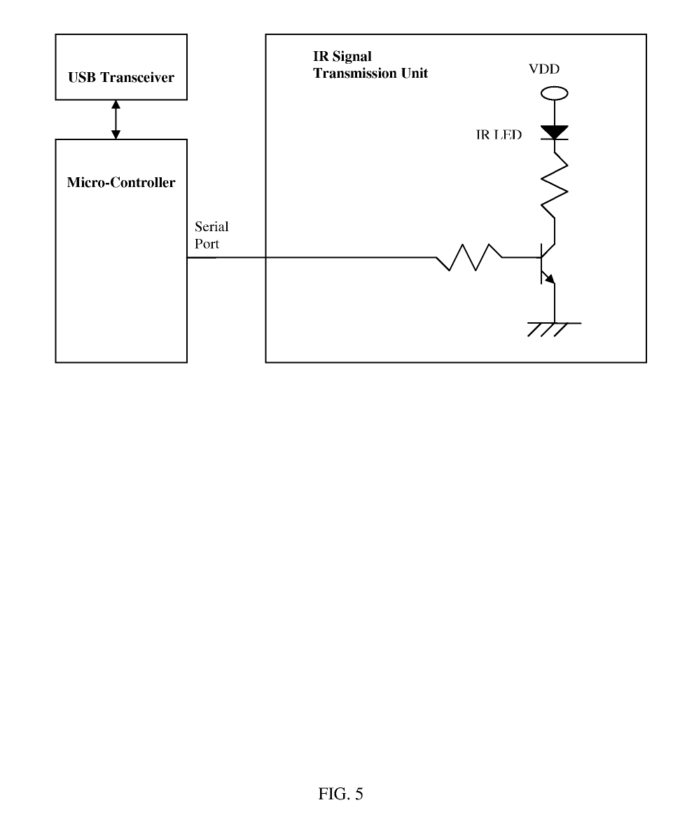

FIG. 5 shows an embodiment of the USB plug-in. The USB plug-in comprises a USB signal transceiver, a micro-controller, and an IR signal transmission unit. The USB signal transceiver converts the USB electrical signal into digital data and vice versa. The micro-controller implements the USB protocol and the aforementioned PDU processing procedure, and it also controls the on/off switch of the IR signal transmitter via a serial port. The IR signal transmission unit comprises an IR LED and an on/off switch.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A plug-in peripheral device to enable smart portable device to control a plurality of electronic appliances, comprising: peripheral bus interface, processor of protocol data unit, and transmitter of remote control code.

2. The plug-in peripheral device of claim 1, wherein said smart portable device comprises: software application that converts user inputs to remote control codes specific to the electronic appliance to be controlled; and means for conveying said remote control codes as said protocol data units to said plug-in peripheral device.

3. The plug-in peripheral device of claim 1, wherein said peripheral bus interface implements the USB interface.

4. The plug-in peripheral device of claim 1, where said protocol data unit is carried in one or more USB data packets.

5. The plug-in peripheral device of claim 1, wherein said protocol data unit comprises a payload that contains the sequence of logic levels representing said remote control code.

6. The plug-in peripheral device of claim 1, wherein said protocol data unit further comprises a level-duration field for controlling the duration of a logic level of said remote control code.

7. The plug-in peripheral device of claim 1, wherein said protocol data unit further comprises a carrier frequency field for controlling the modulation frequency in transmitting said remote control code.

8. The plug-in peripheral device of claim 1, wherein said processor of protocol data unit uses information inside said protocol data unit to control an on/off switch of said transmitter of remote control code.

9. The plug-in peripheral device of claim 1, wherein said transmitter of remote control code transmits remote control code as modulated infrared signals.

10. A method for enabling smart portable device to control a plurality of electronic appliances, comprising: converting user inputs on said smart portable device to remote control codes specific to electronic appliance under control; transmitting remote control codes as protocol data units through peripheral bus interface to a plug-in peripheral device; and using information in said protocol data units to control an on/off switch of a transmitter on said plug-in peripheral device.

11. The method of claim 10, wherein said peripheral bus interface implements the USB interface.

12. The method of claim 10, wherein said protocol data unit is carried in one or more USB data packets.

13. The method of claim 10, wherein said protocol data unit comprises a payload that contains the sequence of logic levels representing said remote control code.

14. The method of claim 10, wherein said protocol data unit further comprises a level-duration field for controlling the duration of a logic level of said remote control code.

15. The method of claim 10, wherein said protocol data unit further comprises a carrier frequency field for controlling the modulation frequency in transmitting said remote control code.

16. The method of claim 10, wherein said transmitter transmits remote control code as modulated infrared signals.

17. A universal remote control system, comprising: a smart portable device that converts user inputs into remote control codes specific to the electronic appliance to be controlled and transmits protocol data units that encode said remote control codes over a peripheral bus interface; and a plug-in peripheral device that receives said protocol data units via said peripheral bus interface and uses information in said protocol data units to control an on/off switch of an infrared signal transmitter.
